(19) United States
(12) Patent Application Publication
(10) Pub. No.: US 2012/0247766 A1
(43) Pub. Date: Oct. 4, 2012

(54) GEOTHERMAL GROUT, METHODS OF MAKING GEOTHERMAL GROUT, AND METHODS OF USE

(76) Inventor: Raymond T. Hemmings, Kennesaw, GA (US)

(21) Appl. No.: 13/437,489

(22) Filed: Apr. 2, 2012

Related U.S. Application Data
(60) Provisional application No. 61/470,659, filed on Apr. 1, 2011.

(51) Int. Cl. E21B 33/13; C04B 28/14; C04B 28/08; C04B 28/00; C04B 18/06; C04B 2/02

(52) U.S. Cl. 166/285; 106/705; 106/707; 106/710; 106/789; 106/791; 106/640; 106/638; 106/788; 106/798

(57) ABSTRACT

The present disclosure relates to geothermal grout, methods of making geothermal grout, and methods of using geothermal grout. The present disclosure is further directed to an geothermal grout with relative ease of preparation and desirable thermal conductivity while maintaining good sealant properties.

### CROSS-REFERENCE TO RELATED APPLICATION

This application claims priority to, and the benefit of, U.S. Provisional Application No. 61/470,659, entitled “Geothermal Grout, Methods of Making Geothermal Grout, and Methods of Use,” which was filed on Apr. 1, 2011, which is incorporated herein by reference in its entirety.

### FIELD OF THE INVENTION

The present disclosure is generally related to a grout designed for use with geothermal heat pump systems.

### BACKGROUND

Geothermal heat pump systems are used to recover energy from the earth. Generally, these systems include a pump, a piping system buried in the earth, an above-ground heat transfer device, and a heat transfer fluid which circulates through the piping system. Installation of these systems includes boring a hole or a series of holes into the earth and inserting a continuous loop of pipe into the hole or series of holes. Grout is poured into the bored hole(s) and surrounds the piping and protects the pipes from ground movement and ground water. Depending on the desired use of the circulating fluid, the ground may act either as a heat source, heating the circulating fluid, or as a heat sink, cooling the circulating fluid.

Currently used grouts are typically either bentonite-based grout or cement-based grout, both of which require labor-intensive preparation. In order to achieve a suitable level of thermal conductivity, sand is incorporated and suspended into these grouts. U.S. Pat. No. 6,251,179 provides a geothermal grout containing cement, silica sand, a superplasticizer, water, and optionally, bentonite. U.S. Pat. No. 4,912,941 discloses a heat-conducting grout made of water, cement, siliceous gel, and metal powder. U.S. Pat. No. 4,993,483 discloses sand or silica particles packed around pipes in the ground in order to thermally stabilize the pipes. U.S. Pat. No. 5,038,580 discloses a thermally-conductive grout comprised of cement alone or includes a mixture of bentonite and water.

These conventional grouts have been used with varying degrees of success. For instance, although bentonite grouts work well as sealants, their thermal conductivity is relatively low and they are not suitable for use in regions with saline groundwaters. Use of cement grouts, on the other hand, often results in the formation of pores in the grout, which significantly decreases thermal conductivity. Additionally, cement grouts are also prone to shrinkage, which decreases their ability to form a good seal between the pipe and surface of the earth.

Geothermal grouts and methods for producing them may be difficult and costly to make and/or install. Additionally, since geothermal grouts known prior to the present disclosure may contain mostly bentonite or neat cement, they have relatively low thermal conductivity. Consequently, in order to improve thermal conductivity, these grouts may require the admixing of sand on the job site, leading to errors in weigh batching. Furthermore, these grouts may be relatively expensive and may contain organic polymers which can degrade over time. Therefore, a geothermal grout is desired that is inexpensive, environmentally friendly, stable, capable of use with standard equipment, and/or which possesses good sealant properties (e.g., low permeability) while maintaining good thermal conductivity.

### SUMMARY

Embodiments of the present disclosure, in one aspect, relate to geothermal grout, methods of making geothermal grout, and methods of using geothermal grout.

Briefly described, embodiments of the present disclosure include a geothermal grout composition, comprising a first component, where the first component comprises a source of reactive silica and alumina, and where the source of reactive silica and alumina comprises about 70% to 95% of the composition; a second component selected from at least one of the following: cement, lime, hydrated lime, lime kiln dust, cement kiln dust, calcium sulfate, and/or any combination thereof, where the second component comprises about 5% to 30% of the composition; and a third component, where the third component comprises a carbon additive, where the carbon additive comprises about 0% to 40% of the composition.

Embodiments of the present disclosure include a geothermal grout composition, comprising: a first component comprising a source of reactive silica and alumina, where the source of reactive silica and alumina comprises about 70% to 95% of the composition, the first component further comprising carbon, the carbon being about 0% to 40% of the composition; and a second component selected from at least one of the following: cement, lime, hydrated lime, lime kiln dust, cement kiln dust, calcium sulfate, and/or any combination thereof, where the second component comprises about 5% to 30% of the composition.

Embodiments of the present disclosure further include a method, comprising the step of: mixing a first component with a second component and a third component to yield a geothermal grout composition, where the first component comprises a source of reactive silica and alumina, and where the source of reactive silica and alumina comprises about 70% to 95% of the composition, and the second component is selected from at least one of the following: cement, lime, hydrated lime, lime kiln dust, cement kiln dust, calcium sulfate, and/or any combination thereof, where the second component comprises about 5% to 30% of the composition, and the third component comprises a carbon additive, where the carbon additive comprises about 0% to 40% of the composition.

Embodiments of the present disclosure also include a method, comprising the steps of: obtaining a first component, wherein the first component comprises a source of reactive silica and alumina, and where the source of reactive silica and alumina comprises about 70% to 95% of the composition; obtaining a second component selected from at least one of the following: cement, lime, hydrated lime, lime kiln dust, cement kiln dust, calcium sulfate, and/or any combination thereof, where the second component comprises about 5% to 30% of the composition; obtaining a third component, where the third component comprises a carbon additive, where the carbon additive comprises about 0% to 40% of the composition; and mixing the first component, the second component, and the third component.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a cross-sectional view of a vertical ground loop of a geothermal heat pump system where an injection of an embodiment of the geothermal grout composition of the present disclosure has been made, taken along line A-A of FIG. 2A.

FIG. 2A illustrates a side view of a bore hole detail of a geothermal heat pump system employing an embodiment of the geothermal grout composition of the present disclosure.

FIG. 2B further illustrates a side view of a ground loop of a geothermal heat pump system for use with embodiments of the geothermal grout composition of the present disclosure.

### DETAILED DESCRIPTION

This disclosure is not limited to particular embodiments described, and as such embodiments may vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Ratios, concentrations, amounts, and other numerical data can be expressed herein in a range format. Such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. For illustration purposes only, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of the numerical value.

As will be apparent to those of skill in the art upon reading this disclosure, each of the individual embodiments described and illustrated herein has discrete components and features which can be readily separated from or combined with the features of any of the other several embodiments without departing from the scope or spirit of the present disclosure. Any recited method can be carried out in the order of events recited or in any other order that is logically possible.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text (“herein-cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### DEFINITIONS

Unless otherwise defined, all technical and scientific terms used herein have the same meaning as commonly understood by one of ordinary skill in the art of inorganic chemistry, earth science, geology, materials chemistry, and the like. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, “one-part” refers to a form of a composition wherein the components are combined together in a single container.

### Discussion

Embodiments of the present disclosure are generally directed to an inexpensive (relative to the prior art), sustainable, environmentally-friendly geothermal grout, which is easy to prepare, and possesses desirable thermal conductivity while maintaining good sealant properties. A grout according to an embodiment of the present disclosure can be employed in connection with geothermal heat pump systems (as described above and illustrated in the Figures) and other similar applications as can be appreciated by one skilled in the art.

Efficiency of geothermal heat pump systems is directly affected by the grout employed. Ideally, the grout possesses relatively high thermal conductivity in order to ensure the transfer of heat between the heat transfer fluid and the earth. The grout forms a seal which is impermeable to fluids that may leak into and/or contaminate the water supply. In addition, the grout has a relatively low viscosity to allow for its placement in the annulus between the heat transfer pipe and the surface of the earth. In order to achieve these properties, various grouts have been developed.

Disclosed herein are compositions designed for use in subterranean operations, such as geothermal well construction. Compositions of the present disclosure may be one-part pozzolanic cementitious compositions suitable for use in the annular space between geothermal well walls and the surface of the earth.

Embodiments of the present disclosure include a geothermal grout composition, comprising a first component, where the first component comprises a source of reactive silica and alumina, and where the source of reactive silica and alumina comprises about 70% to 95% of the composition; a second component selected from at least one of the following: cement, lime, hydrated lime, lime kiln dust, cement kiln dust, calcium sulfate, and/or any combination thereof, where the second component comprises about 5% to 30% of the composition; and a third component, where the third component comprises a carbon additive, and the carbon additive comprises about 0% to 40% of the composition. It should be noted as used and claimed herein that the second component can be any one of the listed items (e.g., cement or lime or hydrated lime, etc.), could be one of each of the listed items (e.g., cement and lime and hydrated lime, etc.), or any combination of the listed items (e.g., cement and lime but not hydrated lime; or cement and hydrated lime but not lime, etc.).

In an embodiment of the present disclosure, the second component can be regarded as an alkaline activator for the amorphous aluminiosilicate component(s). In other words, the second component in the presence of water increases the pH of the mix water and provides available reactive calcium, both of which promote the reaction of the aluminosilicate component (the so-called pozzolanic reaction). The calcium sulfate also contributes positively to the pozzolanic reaction of the aluminosilicate.

In an embodiment of the present disclosure, types of aluminosilicate include fly ash, blast furnace slag, natural pozzolans (e.g., clay, volcanic ash, pumice, zeolites, etc.), and/or blends thereof, containing about 20-100% reactive amorphous aluminosilicate.

In an embodiment of the present disclosure, the carbon additive provides a source of carbon which is advantageous to the composition. Increased carbon is advantageous because it allows for better thermal properties (up to a practical limit of about 40% C, beyond which point properties such as strength and permeability will deteriorate).

Fly ash is a preferred source of the carbon (free) and can be sourced with up to about 25% carbon or more. However, it is also possible that an alternative source of carbon may be blended as an additive. This could be a commercial carbon, such as graphite, or a by-product carbon from another industrial process.

In one embodiment, the first component can be a reactive amorphous aluminosilicate that reacts with a second component (e.g., cement), which can initiate a series of reactions that result in a calcium silicate hydrate that binds the particles of the resultant mixture. As noted above, the first component may include a fly ash that includes carbon, which provides thermal reactivity of the resultant geothermal grout composition.

Fly ash is a preferred source of carbon because it contains a reactive amorphous aluminosilicate glass for the pozzolanic reaction; it has a spherical particle shape, which provides excellent rheological properties for injection and void filling; with proper source selection, it contains a high carbon and iron compound content; and some fly ashes contain lime and calcium sulfates.

In one embodiment, the first component is sourced and/or manufactured with low moisture content. As one example, the moisture content is less than about 0.5% by weight because the second component may react rapidly with water and cause deterioration and/or lumping of the geothermal grout composition during manufacture and/or transport. Accordingly, the moisture content of the geothermal grout composition may be kept low during manufacture and/or transport and until application of the composition in connection with a geothermal ground loop.

Additionally, the second component can comprise a fly ash that does not in all respects comply with the ASTM International standard ASTM C618-08a, entitled “Standard Specification for Coal Fly Ash and Raw or Calcined Natural Pozzolan for Use in Concrete.” Accordingly, a geothermal group composition according to the disclosure can use fly ash that cannot otherwise be used in concrete applications.

Embodiments of the present disclosure include a geothermal grout composition as described above including an additional component, where the additional component is an iron compound selected from at least or any one of: hematite (Fe₂O₃), magnetite/ferrite spinel (Fe₃O₄), metallic iron (Fe), and/or any combination thereof.

In another embodiment of the present disclosure, the geothermal grout composition as described above includes an additional component, where the additional component is a calcium sulfate compound selected from at least or any of: calcium sulfate or anhydrite (CaSO₄), calcium sulfate dihydrate or gypsum (CaSO₄.2H₂O), calcium sulfate hemihydrate (CaSO₄.1/2H₂O), and/or any combination thereof.

In another embodiment of the present disclosure, the geothermal grout composition as described above includes a first additional component, where the first additional component is an iron compound selected from at least or any one of: hematite (Fe₂O₃), magnetite/ferrite spinel (Fe₃O₄), metallic iron (Fe), and/or any combination thereof; and a second additional component where the second additional component is a calcium sulfate compound selected from at least or any one of: calcium sulfate or anhydrite (CaSO₄), calcium sulfate dihydrate or gypsum (CaSO₄.2H₂O), calcium sulfate hemihydrate (CaSO₄.1/2H₂O), and/or any combination thereof. As discussed previously, as used herein in the specification and claims, the above selection of components can include any one of the particular components, each one of the particular components, or any combination of the components.

The geothermal grout composition of the present disclosure exhibits thermal conductivity (e.g., k>about 1.0), sealant properties, minimal shrinkage (e.g., <about −0.15%, i.e., no cracking), low permeability (e.g., <about 9×10⁻¹¹ cm/sec), strength (e.g., about 100-250 psi), and acceptable rheology. In addition, the geothermal grout composition of the present disclosure is stable to a wide range of groundwater pH and salinity conditions.

The geothermal grout composition of the present disclosure is suitable for both commercial and residential use. A difference between commercial and residential use is one of scale; commercial will be more highly specified and attracted to high thermal performance. High thermal conductivity permits reduced size for well boring and associated piping, resulting in significant cost savings for drilling and material use.

Embodiments of the present disclosure include a geothermal grout composition that is a one-part formulation. “One-part” means that all the components of the grout can be provided in one bag. With bentonite and sand or cement and sand, for example, the components are provided separately and have to be blended on the job site. This is prone to significant errors and “creativity” on the part of the contractor who might dilute the expensive bentonite with more sand. A one-part system improves quality control and/or quality assurance (QC/QA) and reduce operator errors. The one-part system of the present disclosure simplifies logistics and reduces costs at the job site. A pile of sand and use of a skid loader, bulldozer, other earth moving machinary can be avoided, which can result in energy savings, reduced transportation costs, and environmental impact of transportation reduced.

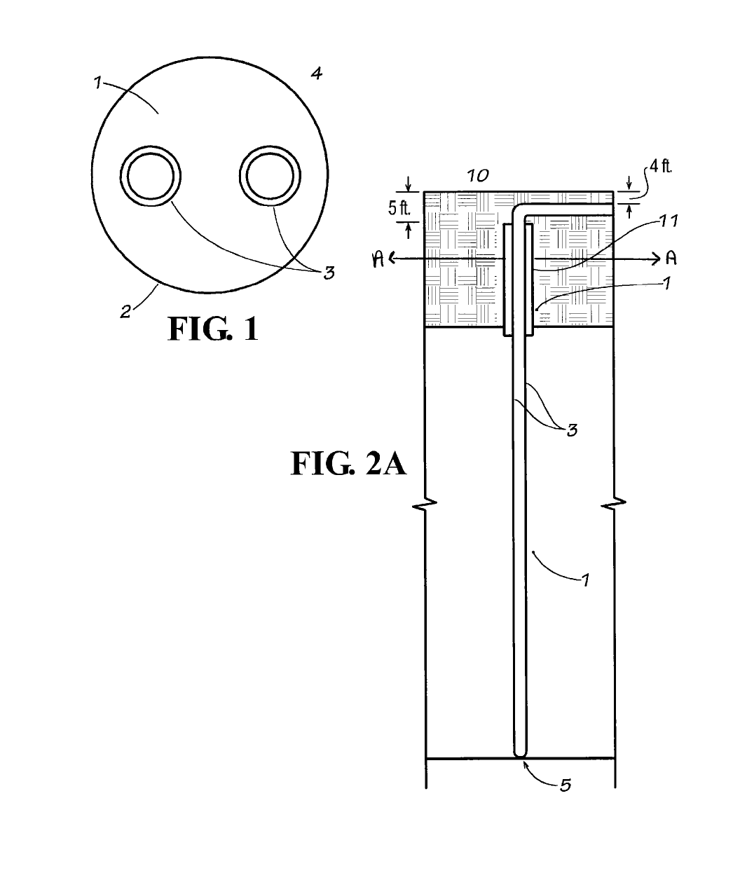

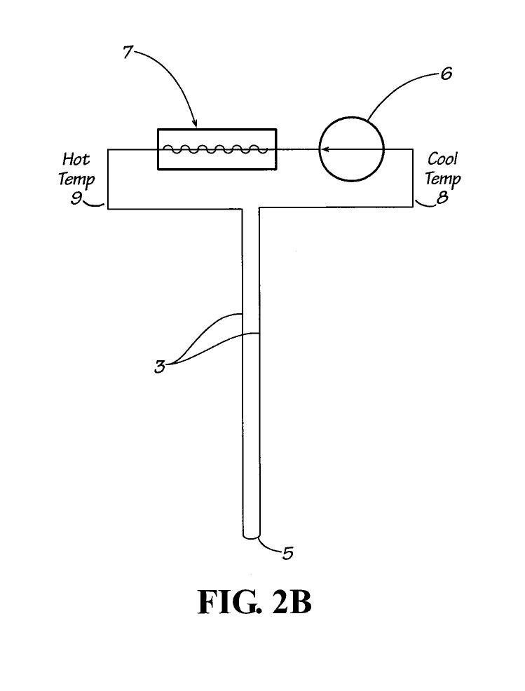

FIG. 1 illustrates a vertical ground loop of a geothermal heat pump system employing an embodiment of the geothermal grout composition 1 of the present disclosure. FIG. 1 is a view taken along line A-A of FIG. 2A. The geothermal grout composition 1 is injected into bore holes 2 made in the soil 4 to surround at least a portion of the piping 3 (i.e., heat transfer piping) of the ground loop.

FIG. 2A illustrates the bore hole 2 detail of a geothermal heat pump system employing an embodiment of the geothermal grout composition of the present disclosure. When the bore hole 2 is grouted, the filling tube 11 is inserted all the way to the bottom of the hole prior to the injection of the grout 1. This filling tube (sometimes referred to as a “Tremie” tube) is gradually withdrawn out of the bore hole 2 as the annulus space is filled with grout 1. The piping 3 of the geothermal heat pump system is buried under the surface 10 of the earth. The piping 3 forms a u-bend 5 at the bottom of the system.

As illustrated in FIG. 2B, in a geothermal heat pump system, a heat transfer fluid circulates 6 through the piping system where it is heated with a heat source 7 prior to circulating in the piping 3 below the surface of the ground. The ground acts as a heat sink on the supply side 9, cooling the circulating fluid, which is returned on the return side 8. In the alternative, the ground acts as a heat source, heating the circulating fluid.

Accordingly, application of the geothermal grout composition in connection with a geothermal ground loop involves mixing of the composition with water and injection of the geothermal grout composition into bored hole(s) to surround at least a portion of the piping of the loop. The ease of application of the one-part system of the present disclosure can be advantageous for a contractor applying the geothermal grout composition relative to a bentonite and/or bentonite/sand application. In one embodiment, an amount of the geothermal grout composition according to the present disclosure is mixed with water in a high speed mortar-type mixer to achieve the desirable consistency for fluidity and pumping. In some embodiments, this can be achieved using a positive displacement (e.g., piston-type) or similar pump suited for pumping high solids mixes. In one embodiment, suitable fluidity of a mixture of the geothermal grout composition and water can be verified in the field with a flow test, which should show a spread flow of about 8″±2″ from the contents of a 3″×6″ cylinder. In this non-limiting example, achieving such a flow test can require a water-to-grout ratio of between about 60:40 and about 25:75 (i.e. about 40-75% geothermal grout composition by weight) for most fly ashes that are employed as the first component. The water-to-grout ratio can vary based at least upon the properties of the first component. In one embodiment, if the first component is a fly ash, the water-to-group ratio can vary depending upon the particle size of the fly ash. For example, the fly ash may possess fine particles with high surface area and high water demand. In such a scenario, more water may be required in order to achieve desirable consistency of a resultant mixture. Alternatively, a fly ash with coarse particles may require less water to achieve desired fluidity. Additionally, the carbon content of the grout composition can also affect the amount of water required in order to achieve desired fluidity. In some embodiments, a higher carbon content can require more water to achieve desired fluidity relative to a geothermal grout composition having a lower carbon content.

1. A geothermal grout composition, comprising:
a first component, wherein the first component comprises a source of reactive silica and alumina, and wherein the source of reactive silica and alumina comprises about 70% to 95% of the composition;
a second component selected from at least one of: cement, lime, hydrated lime, lime kiln dust, cement kiln dust, calcium sulfate, and any combination thereof, wherein the second component comprises about 5% to 30% of the composition; and
a third component, wherein the third component comprises a carbon additive, wherein the carbon additive comprises about 0% to 40% of the composition.

2. The geothermal grout composition of claim 1, wherein the source of reactive silica and alumina is selected from at least one of: fly ash, blast furnace slag, natural pozzolans, and any combination of fly ash and blast furnace slag.

3. The geothermal grout composition of claim 1, wherein the source of reactive silica and alumina contains about 20% to 100% reactive amorphous aluminosilicate.

4. The geothermal grout composition of claim 1 further comprising an additional component, wherein the additional component is an iron compound selected from at least one of: hematite (Fe₂O₃), magnetite/ferrite spinel (Fe₃O₄), metallic iron (Fe), and any combination thereof.

5. The geothermal grout composition of claim 1 further comprising an additional component, wherein the additional component is a calcium sulfate compound selected from at least one of: calcium sulfate or anhydrite (CaSO₄), calcium sulfate dihydrate or gypsum (CaSO₄.2H₂O), calcium sulfate hemihydrate (CaSO₄.1/2H₂O), and any combination thereof.

6. The geothermal grout composition of claim 1, further comprising a first additional component, wherein the first additional component is an iron compound selected from at least one of: hematite (Fe₂O₃), magnetite/ferrite spinel (Fe₃O₄), metallic iron (Fe), and any combination thereof; and a second additional component wherein the second additional component is a calcium sulfate compound selected from at least one of: calcium sulfate or anhydrite (CaSO₄), calcium sulfate dihydrate or gypsum (CaSO₄.2H₂O), calcium sulfate hemihydrate (CaSO₄.1/2H₂O), and any combination thereof.

7. The geothermal grout composition of claim 1, where the composition exhibits at least one of: thermal conductivity, sealant properties, minimal shrinkage, low permeability, strength, and acceptable rheology.

8. The geothermal grout composition of claim 1, where the composition is suitable for commercial and residential use.

9. A geothermal grout composition, comprising:
a first component comprising a source of reactive silica and alumina, wherein the source of reactive silica and alumina comprises about 70% to 95% of the composition, the first component further comprising carbon, the carbon being about 0% to 40% of the composition; and
a second component selected from at least one of: cement, lime, hydrated lime, lime kiln dust, cement kiln dust, calcium sulfate, and any combination thereof, wherein the second component comprises about 5% to 30% of the composition.

10. The geothermal grout composition of claim 9, wherein the first component further comprises at least one of: fly ash, blast furnace slag, natural pozzolans, and any combination of fly ash, blast furnace slag, and natural pozzolans.

11. A method, comprising the step of:
mixing a first component with a second component and a third component to yield a geothermal grout composition, wherein the first component comprises a source of reactive silica and alumina, and wherein the source of reactive silica and alumina comprises about 70% to 95% of the composition, and the second component is selected from at least one of: cement, lime, hydrated lime, lime kiln dust, cement kiln dust, calcium sulfate, and any combination thereof, wherein the second component comprises about 5% to 30% of the composition, and the third component comprises a carbon additive, wherein the carbon additive comprises about 0% to 40% of the composition.

12. A method, comprising the steps of:
obtaining a first component, wherein the first component comprises a source of reactive silica and alumina, and wherein the source of reactive silica and alumina comprises about 70% to 95% of the composition;
obtaining a second component selected from at least one of: cement, lime, hydrated lime, lime kiln dust, cement kiln dust, calcium sulfate, and any combination thereof, wherein the second component comprises about 5% to 30% of the composition;
obtaining a third component, wherein the third component comprises a carbon additive, wherein the carbon additive comprises about 0% to 40% of the composition; and
mixing the first component, the second component, and the third component.

13. The method of claim 12, wherein the step of mixing the first component, the second component and the third component further comprises mixing the first component, the second component and the third component in a batch weighing system.

14. The method of claim 11, further comprising mixing the composition comprised of the first component, the second component, and the third component with water and injecting the composition into at least one bored hole in the surface of the earth so that the composition surrounds at least a portion of a pipe of a loop of a geothermal heat pump system.

15. The method of claim 12, further comprising mixing the composition comprised of the first component, the second component, and the third component with water and injecting the composition into at least one bored hole in the surface of the earth so that the composition surrounds at least a portion of a pipe of a loop of a geothermal heat pump system.
